(19) United States
(12) Patent Application Publication
(10) Pub. No.: US 2013/0321627 A1
(43) Pub. Date: Dec. 5, 2013

(54) ROAD DEPARTURE SENSING AND INTELLIGENT DRIVING SYSTEMS AND METHODS

(71) Applicants: John C. Turn, JR., San Jose, CA (US); Paul W. Hoff, Bedford, NH (US); Don J. Ronning, Nashua, NH (US); Hamilton M. Stewart, Hollis, NH (US)

(72) Inventors: John C. Turn, JR., San Jose, CA (US); Paul W. Hoff, Bedford, NH (US); Don J. Ronning, Nashua, NH (US); Hamilton M. Stewart, Hollis, NH (US)

(21) Appl. No.: 13/485,112

(22) Filed: May 31, 2012

(51) Int. Cl. H04N 7/18; B60Q 1/00

(52) U.S. Cl. 348/148; 340/439; 348/E07.085

(57) ABSTRACT

A Road Departure Sensing and an Intelligent Driving System which uses near-infrared illumination to collect a continuous sequence of images from an area ahead of a moving vehicle, measure the distance to potential obstacles or obstructions, calculate the potential for collisions, detect the edges of a road or path or changes in the surface texture of a driving surface, and warn a vehicle operator in advance of the vehicle departing the drivable surface or communicate with an unmanned vehicle navigation system to sense and supply real-world navigational data. The unmanned vehicle navigation system can be integrated with existing civilian or military vehicles to provide autonomous or semi-autonomous vehicle operation.

### FIELD OF THE INVENTION

The present invention is directed to various embodiments of a Road Departure Sensing System and an Intelligent Driving System which can collect a continuous sequence of images from an area ahead of a moving vehicle, measure the distance to potential obstacles, calculate the potential for collisions, and warn the operator in advance of the vehicle departing the drivable surface or communicate with an unmanned-vehicle navigation system.

### BACKGROUND OF THE INVENTION

In the theatres of war in Iraq and Afghanistan extremists have used weapons of opportunity such as roadside bombs and improvised explosive devices (IEDs) to wage war. One response to mitigate the effects of roadside bombs and IEDs is to raise the hull of military vehicles to increase ground clearance. Raising a vehicle raises its center of gravity which increases the likelihood of “tripping” rollovers. A tripping rollover can occur when the outside wheels of a vehicle strike a curb, enter a soft shoulder, or encounter a change in grade. The center of gravity moves beyond these outer wheels and the vehicle is said to “trip” and a rollover commences. High center of gravity vehicles, such as the Mine Resistant Ambush Protected (MRAP) vehicle and the Joint Light Tactical Vehicle (JLTV), are prone to tripping in this manner. Tripping can also occur with mining or farm vehicles that operate in rural or “off-road” conditions on unpaved or soft-shoulder paths or trails. A “tripping” type of rollover typically occurs at a road's edge where the road can be bordered by a ditch or berm. A soft dirt shoulder that may or may not include vegetation could define the edge of a dirt road or track soft. Abruptly encountering any of these drivable or non-drivable combinations can change the friction condition between the road and tire surface causing the vehicle to trip. Avoiding road edges can help mitigate tripping and reduce the likelihood of encountering this type of rollover problem.

There are examples of optical cameras equipped with algorithms to find road edges on improved roads, such as highways, freeways, and secondary roads. These optical camera systems generally operate only in daylight conditions on a structured road. These systems do not operate well at night, on unstructured dirt roads, or tracks with dirt shoulders. For example, “Application Analysis of Near Infrared Illuminators Using Diode Laser Light Sources,” by Stout and Fohl, published in the Proceedings of the SPIE, Vol. 5403, which is incorporated herein by reference, teaches the use of an infrared illuminator and CCD or CMOS sensors to create images.

Light Detection and Ranging (LIDAR) systems utilizing a narrow laser beam can be used to map physical features with very high resolution and such systems have previously been utilized for experimental vehicle navigation systems. However, the cost of multiple 2-D or 3-D LIDAR sensors has generally limited their use to expensive or experimental systems. Existing systems are also not capable of operation in a harsh military environment.

Current unmanned ground vehicles (UGVs) rely on electro-optical (EO) cameras and/or LIDAR sensors for viewing the road ahead of the vehicle. Use of these sensors creates limitations on the operation of the vehicle. Common EO sensors are useful in daylight but are not optimal for nighttime or low light operations.

### SUMMARY OF THE INVENTION

Embodiments of the present invention are directed toward a Road Departure Sensing System (RDSS) which collects a continuous sequence of images from the area ahead of a forward moving vehicle, processes these images, establishing drivable and non-drivable surfaces, and communicates a warning to the driver in advance of the vehicle departing the drivable surface. An embodiment of the system can extract information from images in day or night conditions to discern drivable and non-drivable surfaces and to provide warnings automatically on improved roads, for instance, highways, freeways, and secondary roads, or dirt roads with or without dirt shoulders. The RDSS can operate under changing lighting conditions in both day and night-time illumination. Providing ample warning to the vehicle's driver can help to mitigate road departure accidents, reducing both equipment cost and the risk of injury or death to the vehicle's occupants.

In one embodiment, a RDSS operates with the aid of self-contained infrared illumination. A charge coupled device (CCD) sensor collects reflected electromagnetic radiation from the visible as well as near infrared spectrums making the system operable in either day or night. The RDSS includes image analysis algorithms that extract both edge and texture information from an image. Being equipped to analyze both edges and textures provides the system with the capability to operate on structured highways, freeways, secondary paved roads, and dirt roads with dirt or grass shoulders. The RDSS can act to warn the driver of a vehicle that the path that the vehicle is moving on will result in an imminent departure from the road based on an analysis of edges and surface textures of the road and surrounding area. In one embodiment the RDSS can issue a warning at least one to two seconds prior to road departure. The advanced warning provides the driver with sufficient time to react and change course to avoid a vehicle-tripping incident.

In one embodiment the RDSS can be manually or automatically adjusted, through real world operation, to minimize false alarm rates and maximize true positive rates. The system does not need to take control of the vehicle; it can issue an audible or other alert to the driver to attend to changing the current course of the vehicle to avoid a potentially catastrophic rollover. The system is compact and can support many different mechanical shapes and configurations. One embodiment utilizes a commercially available single board computer, in combination with a DDC camera and IR illumination, in a rugged, durable design built to operate in extreme ambient temperature environments.

In one embodiment, the RDSS includes a built in illuminator in the near infrared spectrum that allows for day or night operation. Without input from the driver or operator, high-resolution images are obtained to determine fine detail of the area ahead of a vehicle to allow discernment of road edges and textures that indicate a change between a drivable and a non-drivable surface. In addition to use for road departure warning, an embodiment of the system can be combined with an appropriate radar or navigation system to provide a driving sensor system for unmanned ground vehicles.

In one embodiment, an Intelligent Driving Sensor Suite (IDDS) in combination with an RDSS embodiment provides vehicles with a sensor suite for autonomous (unmanned) operation or for manned driver assistance that is low-cost, rugged, and reliable. The IDDS includes a near infrared illuminated IR imaging sensor, algorithms to optimize the image quality in real time, and a laser range finder or a microwave radar transceiver and algorithms for data analysis to determine object extent, range, and bearing data for objects on the drivable surface in the intended path ahead of a vehicle.

An IDDS processor configured with a data fusion algorithm continuously provides object extent, range to the object, and bearing angle or heading of the object to the vehicle to collision avoidance software which uses the information to correct the path of the vehicle to avoid objects in the path of the vehicle.

One embodiment of IDDS, provides a sensor suite for autonomous driving capability that is much less expensive than the cost of experimental unmanned vehicle systems and can be integrated with low-cost, low-weight vehicles, such as cars, light trucks, tactical trucks or MTV; and is an easy upgrade to heavy platforms, such as farm equipment, mining vehicles, or the Bradley family of vehicles, the ground combat vehicle, or a marine personnel carrier. One advantage of a near IR illuminated sensor in an IDDS is the ability to discern the boundary of the drivable surface from non-drivable shoulder. This advantage derives from the fact that a passive IR sensor tuned to any wavelength will not distinguish between a road and its shoulder if both are constructed of the same material (same emissivity) and both are at the same temperature.

One embodiment of the present invention, combining the IDDS and the RDDS, can be integrated with existing passenger vehicles to provide warning, alerts, or the application of the vehicle's brakes when a road-departure event is anticipated. The IDDS and RDDS can also be utilized in conjunction with existing passenger vehicle back-up warning systems to alert a driver if a vehicle is about to depart from a road surface or strike a curb while the vehicle is being driven in reverse.

### BRIEF DESCRIPTION OF THE DRAWINGS

The invention may be more completely understood in consideration of the following detailed description of various embodiments of the invention in connection with the accompanying drawings, in which:

FIG. 1 depicts a block diagram of RDSS with an illuminated sensor system according to an embodiment of the invention.

FIG. 2 depicts a block diagram of an IR sensor system according to an embodiment of the invention.

FIG. 3 depicts an IR sensor housing according to an embodiment of the invention.

FIG. 4 depicts a block diagram of the IR sensor system.

FIG. 5 depicts a front perspective view of the sensor housing of FIG. 4.

FIG. 6 depicts the assembly of a laser diode holder and assembly according to an embodiment of the invention.

FIG. 7 depicts a cross-sectional illustration of an optical assembly.

FIG. 8 depicts a flow diagram of the signal transfers between components according to an embodiment of the invention.

FIG. 9 depicts an exemplary embodiment of a circuit board housing according to an embodiment of the invention.

FIG. 10 depicts a generic trapezoidal road view according to an embodiment of the invention.

FIG. 11 depicts a definition of various regions of interest of a road view according to an embodiment of the invention.

FIG. 12 depicts a test image and associated histogram charts.

FIGS. 13A-13B depict a logic flow diagram analyzing ROI gray scale histograms.

FIG. 14 depicts a logic flow diagram for road edge-lane detection according to an embodiment of the invention.

FIG. 15 depicts an urban road scenario with various image characteristics.

FIG. 16 depicts a rural dirt road with an edge detection algorithm applied to outline the road edges.

FIG. 17 depicts a rural farm road with grass present in the road.

FIG. 18 depicts a wooded road scenarios with an edge detection algorithm applied.

FIG. 19a depicts a road scene image acquired by an exemplary RDSS.

FIG. 19b depicts the road scene of FIG. 19a and a searching radar field of view.

FIG. 19c depicts the road scene of FIG. 19a and a radar detecting a potential obstacle.

FIGS. 20a and 20b depict the IDDS cooperation of an optical RDSS with a radar sensor.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF THE DRAWINGS

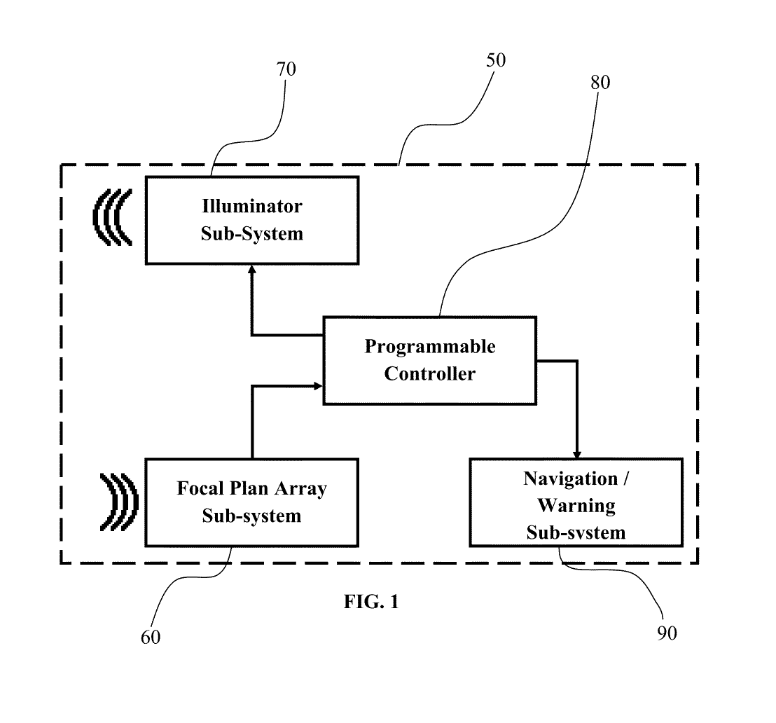

Referring to FIG. 1, an exemplary Road Departure Sensing System (RDSS) 50 is comprised of electrical, electronic, and optical hardware, and software operating on a microprocessor, which controls a near infrared (IR) laser, collects and manipulates images from a focal plane array (FPA), extracts information from the images related to roads, obstacles, and road boundaries or edges, compares the road edge to the path of the vehicle 51, and warns the driver in advance of a possible vehicle departure from the road.

FIG. 1 depicts an exemplary block diagram of a RDSS system 50 having a FPA sub-system 60 that receives or captures images of a path ahead of the vehicle 51 that is illuminated by an illuminator sub-system 70. A programmable controller 80 activates the illuminator sub-system 70 when the system is in operating and receives digital image signals from the FPA assembly 60. The controller 80 continuously processes and evaluates the digital image signals received from the FPA assembly 60. The controller 80 can process, evaluate, and adjust the capture of digital images for exposure quality, brightness, contrast, individual pixel intensity, or any other appropriate variables to provide an accurate depiction of the actual objects in the digital images. Improperly exposed images are discarded and real-time adjustments are made to capture images that can be analyzed and provide useful data. Sub-system 90 provides navigation data or warning indication signals based on an evaluation of the images using edge detection and texture analysis processing. The evaluated images are combined with the vehicle's speed and heading to determine if the trajectory of the vehicle will encounter an obstacle or depart the road surface at excessive speed.

An exemplary IDDS combines an embodiment of an RDSS 50 with a ranging laser or radar to provide alerts, to a driver or autonomous vehicle navigation system, of potential obstacles or obstructions, and to provide sensor data to an vehicle navigation system in real-time.

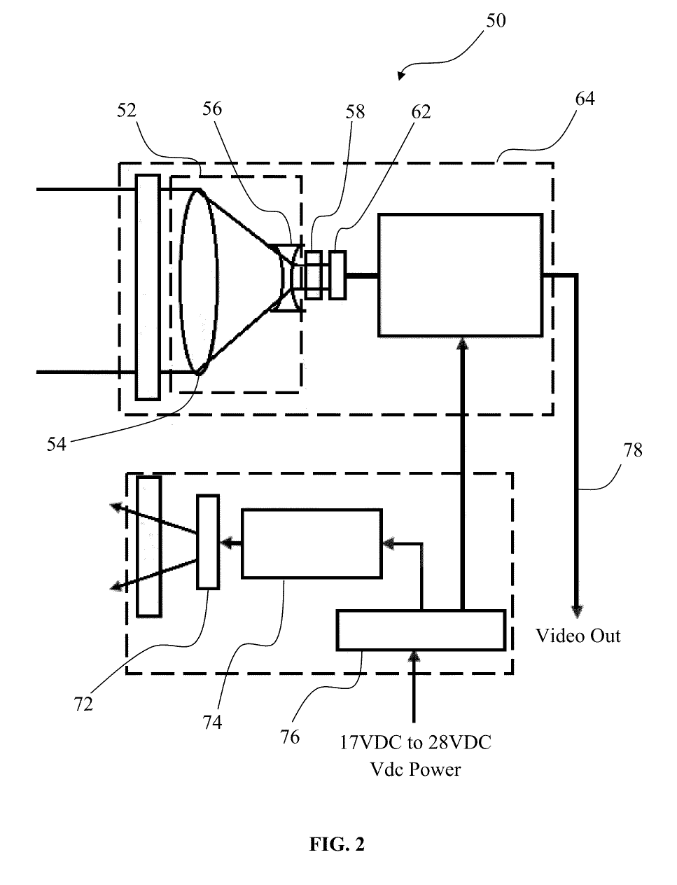

FIG. 2 depicts a schematic diagram of an exemplary RDSS system 50 that includes three sub-systems. The first sub-system is an optical camera assembly 52 that includes a collecting optic or lens 54, collimating optics 56, and a filter 58. The optical camera assembly 52 is configured to direct light, including light in both the visible and infrared spectrums, into an FPA assembly 60. The FPA assembly 60 includes a sensor 62, and a software driver and interface circuitry 64 for the sensor 62. Embodiments of the FPA can be fabricated using any of a variety of different techniques and technologies. The example described herein depicts an FPA sensor based on charge coupled device (CCD) technology, however other FPA technologies, for example CMOS sensors, are applicable and can also be utilized. The RDSS assembly 50 also includes a near-infrared illuminator sub-system 70 that includes a laser diode 72, a laser diode driver 74, and an associated power supply 76 coupled to the laser diode driver 74 and the interface circuitry 64 of the FPA assembly 60. The NIRIS system 50 can provide a continuous stream of captured image data from the sensor 62 to a video output 78. Image data is capture from the sensor 62 by acquiring the data values representing the intensity of light falling on each pixel of the sensor 62 and then transmitting the values, row-by-row, to a processor for evaluation and analysis once a capture of the data from each pixel is complete.

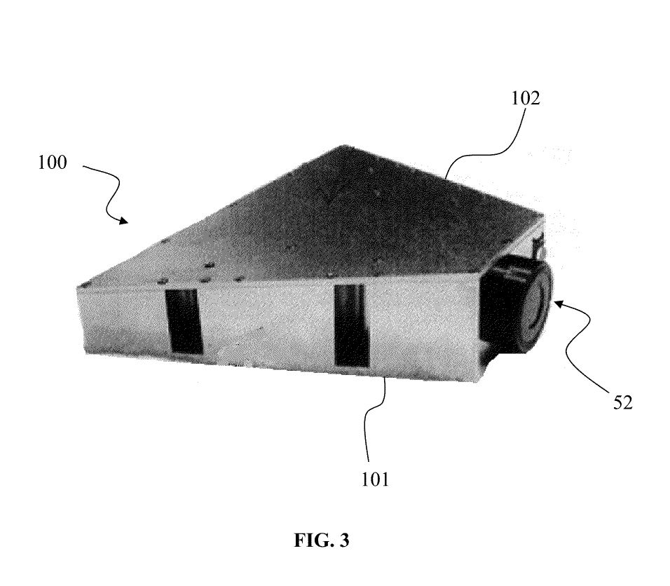

FIG. 3 depicts an exemplary embodiment of a RDSS assembly 100 in a trapezoid configuration that can include an NIRIS sensor system 50, or equivalent camera assembly 52 and an illuminator assembly 70. In one embodiment, a housing 101 can be constructed of wrought aluminum alloy, and sized to hold the main camera components and sub-assemblies. Housing 101 can include a mating cover plate 102 that is secured to the sides of the housing 101 with cap screws and steel inserts. A gasket can be included to fit between the cover plate 102 and housing 101 to form a seal to protect the interior of the assembly 100 from the ambient environment. In an alternative embodiment, the materials of construction of the housing 101 and cover plate 102 can be an injection moldable polymer joined together with screws or other appropriate fasteners.

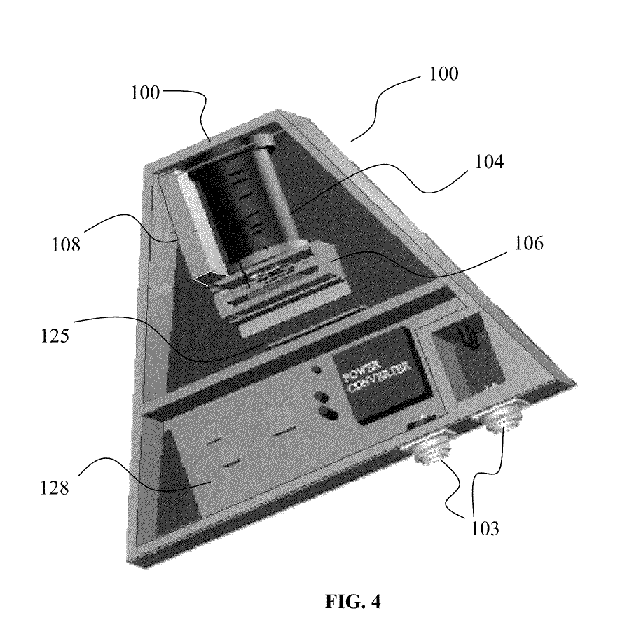

Referring to FIG. 4, power and signal connectors 103 can be mounted on one side of the housing 101 to provide electrical power from the vehicle to the system, and electronic signals between the RDSS assembly 100 and the vehicle. The electronic signals from the vehicle to the system can include data indicating the speed and steering angle of the vehicle that allow the RDSS to calculate the vehicle's trajectory in real time. The RDSS system can provide a signal to the vehicle providing one or more alarms indicating that the speed and steering angle of the vehicle are such that the vehicle is on a trajectory to depart the road or path ahead of the vehicle.

A warning signal can be presented to the operator of the vehicle as an auditory or optical alert indicating that the operator should reduce speed and/or change the steering angle. The alert can be presented with varying degrees of severity. For example, a severe alert can be issued when the vehicle is traveling at a high rate of speed and the operator changes the steering angle such that a road departure is imminent. A less severe alert can be raised in a situation where the vehicle is approaching the boundary of a road or path while traveling at a moderate or low speed where there is a lesser risk of a vehicle rollover or tripping condition.

FIG. 4 also depicts an internal component layout of the exemplary RDSS system 100 with the cover plate 102 removed. An optical assembly 104 is mounted in the housing with a rear mount that can also hold the CCD assembly 106 in position on the central axis of the optical assembly 104. The mount thereby properly aligns the CCD assembly 106 with the optical assembly 104. The laser diode assembly 108 can also be mounted inside the housing 101 at a position adjacent to and in a parallel orientation relative to the optical assembly 104. Both the optical assembly 104 and the laser-diode assembly 108 can be positioned such that they face a window or aperture formed in the forward surface 110 of the housing 101.

Disposed behind the optical assembly 104, CCD assembly 106 includes a CCD sensor coupled to a CCD controller board 154, a PCI to IEEE-1394 board, and camera controller board 125. The PCI to IEEE-1394 board can be configured to acquire images, or frames, from the CCD sensor and provide the digital image data to the camera controller board 125 over a PCI bus. Camera controller 125 is disposed adjacent to the CCD assembly 106. The camera controller board 125 includes an interface to the main circuit board 128 that includes a processor and a system power supply.

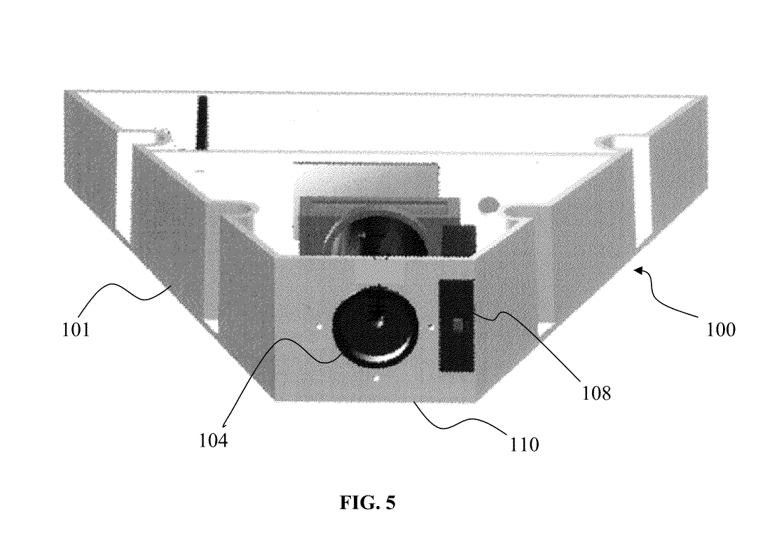

FIG. 5 depicts a perspective view of a front face 110 of the RDSS assembly 100. The camera for the optical assembly 104 and laser-diode illuminator assembly 108 are positioned in two openings formed in the front face 110 of the housing 101. A nominal field of view of these components in the depicted configuration is approximately 32° azimuth and 12° elevation.

In one embodiment the laser-diode illumination assembly 108 comprises a laser diode 130 that can be any of a variety of commercially available laser diodes that emits infrared electromagnetic radiation having a wavelength of approximately 808 nm. Additional or alternative laser diodes of different wavelengths can also be employed with appropriate adjustment to the filters and detection sensor(s) to accommodate the alternative wavelength(s).

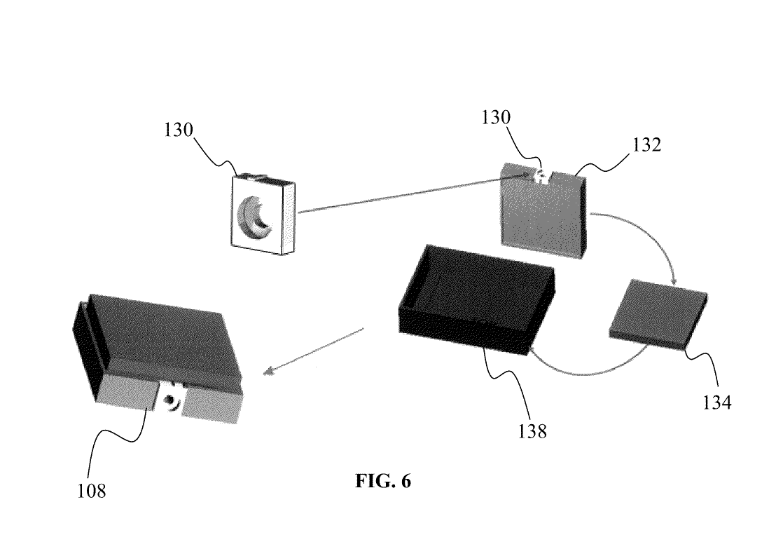

Referring to FIG. 6, the laser diode assembly 108 includes a laser diode 130 that in one embodiment is attached to a mounting block 132 that can be manufactured from a wrought aluminum alloy. The diode 130 and block 132 are also attached to a cold plate 134. In one embodiment a screw, bolt, or other fastener can attach the cold plate 134 to the laser diode assembly is attached to a mounting block 138. The laser diode 130 block 132, and cold plate sub-assembly 134 can alternatively be attached to a commercially available thermoelectric cooler. The complete laser diode assembly 108 can be mounted in a laser diode housing that also acts as a heat sink.

In one aspect, the system includes a control circuit for activating the laser diode 130 also checks the wheel speed of the vehicle, a signal extracted from a CAN bus of the vehicle, to ensure the vehicle is moving at a preset slow speed of approximately five miles-per-hour (mph) before initiating laser diode activation. The circuit checks the wheel speed and issues the trigger pulse to maintain the power to activate the laser diode. This circuit ensures that during maintenance or other idle time the laser will remain inactive protecting any unsuspecting or unaware person.

At the USB interface connection a signal is received to turn on the NIRIS sensor. If health and status are good the laser diode controller is turned on. When appropriate command word(s) are received via the USB interface to turn on the laser diode 130, MOS B is turned on and a trigger is issued to a timing device, such as the depicted NE555 timer. The timing device produces defined (e.g., five-second) pulse once triggered. This pulse turns on MOS Switch A. If a subsequent trigger is not received within five seconds the output goes to zero volts, the MOS switch A is off and the laser diode 130 is off.

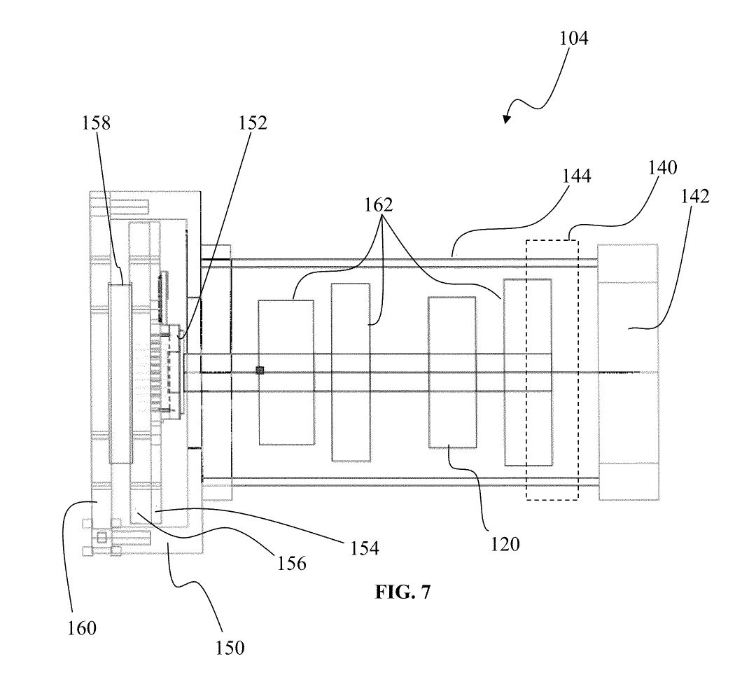

Referring to FIG. 7, an embodiment of optical assembly 104 includes an optical assembly backing ring 140 and front mounting ring 142 to hold the optical assembly 104 to a housing or mounting bracket. An exterior tube or barrel 144 forms the body of the assembly 104 and includes any lenses or filters, such as band-pass filter 120, to direct light to the CCD sensor 152.

The rear mount 150 provides a housing for the cold plate 156, the attached cooler 158, and a heat sink 160 to transfer heat away from the cooler. The heat sink 160 can dissipate excess thermal energy to the atmosphere or be thermally coupled to a large assembly such as a housing 101 or a mounting assembly on a vehicle.

Referring to FIG. 7, an embodiment of the optical assembly 104 is depicted that includes a CCD sensor 152 mounted on the CCD controller board 154. The optical assembly 104 also includes on a cold plate 156 and a thermoelectric cooler 158 that are coupled to the CCD controller board 154. The thermoelectric cooler 158 functions to maintain the desired operating temperature of the sensor by transferring heat from the sensor 152 to the mount 150 and associated RDSS assembly or housing.

The CCD assembly 106 is held in the optical assembly 104 by a rear optical assembly mount 150 and heat sink 160. Lenses 162 are mounted in the optical assembly along then central axis of the CCD sensor 152 and focus light into the sensor. Additionally, the optical assembly 104 includes a band-pass filter 120 that can be configured to selectively transmit a narrow range of wavelengths while blocking all others. In one embodiment the band-pass filter 120 blocks wavelengths that are not approximately 808 nm from reaching the CCD sensor 152. Alternative band pass filters can be utilized to block background light such as sunlight, fires, flares, etc.

A replaceable window 164 closes the optical tube 144 and protects the interior of the optical tube (lenses 162, filter 120, CCD sensor 152, and associated electronics) from the ambient environment while allowing the appropriate light or IR radiation to enter the assembly 104. The window 164 can be transparent or include a variety of filters to further optimize the performance of the CCD sensor 152.

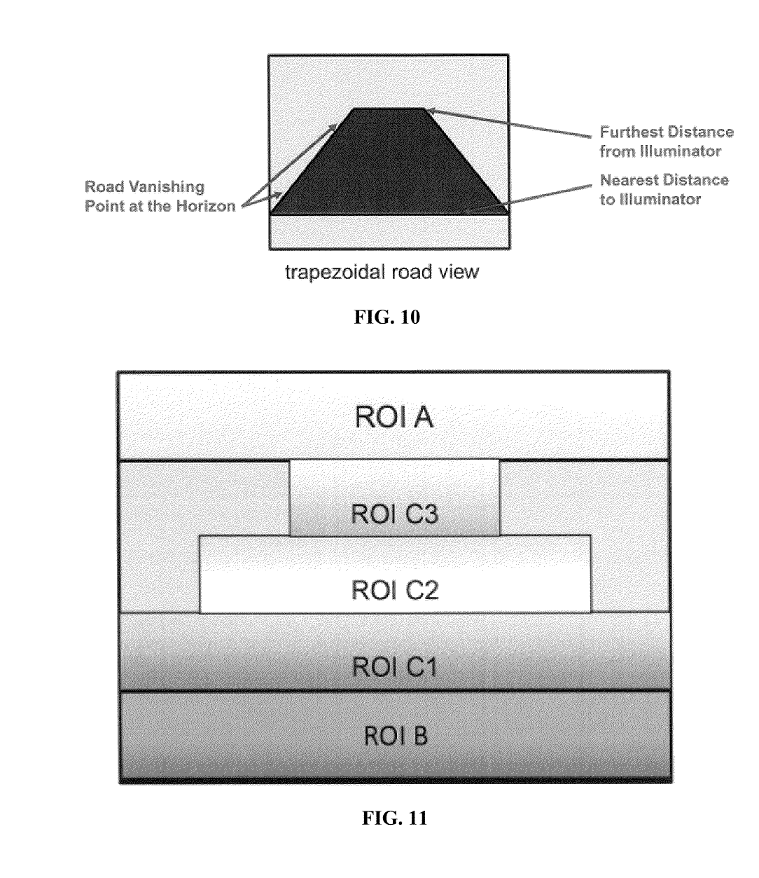

Referring to FIG. 7, a CCD controller board 154 can include a thermoelectric (TE) cooler 158 that can transfer heat to a heat sink 160. The thermoelectric (TE) cooler 158 can also include a thermocouple to monitor the temperature of the controller board 154. As show in FIG. 10D the combination of the controller board 154, TE cooler 158, heat sink 160, and CCD sensor 152 can be assembled into a compact sandwich-style assembly to form a the CCD assembly of a RDSS.

In one embodiment the CCD sensor 152 can be an interline transfer CCD with progressive scan, having a resolution of 640 horizontal pixels and 480 vertical pixels. In one embodiment a CCD sensor 152 can be a commercially available unit such as the KAI-0340 IMAGE SENSOR available from Kodak, Image Sensor Solutions, of Rochester, N.Y. Alternative image sensors can be substituted for alternate resolutions depending on cost, processor capability, and performance goals. Higher resolutions sensors will require a corresponding increase in processor capability to meet the real-world performance needs of an RDSS System.

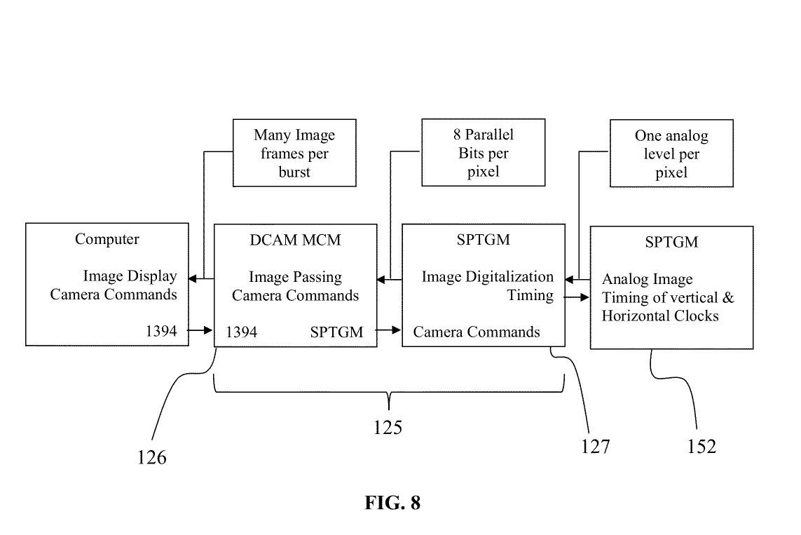

FIG. 8 depicts the simplified signal flow diagram for the commands to control the CCD sensor 152 and the resulting images received from the CCD sensor 152 by a computer processor that those commands produce. The CCD assembly 106 receives commands from software hosted in the processor on camera controller board 125. Those commands arrive in DCAM format at the camera controller board 125 that includes a Frame Capture DCAM multi-chip-module (MCM) 126, such as a multi-chip assembly by ORSYS (available from Traquair Data Systems, Inc.), and a signal processor and timing generator module (SPTGM) 127, such as an Analog Devices AD9929 CCD chip. The DCAM MCM 126 employs a look-up table to convert commands to a format compatible with the SPTGM. These commands flow to the SPTGM 127 which produces timing clocks for vertical and horizontal harvesting of electrons collected by pixels in the CCD sensor 152. In the reverse direction, electron counts are digitized and images are streamed to the host NIRIS processor 125 the image adjustment and pre-processing and feature extraction.

During operation, the SPTGM controller converts each pixel of stored charge into an eight-bit value. The DCAM MCM module contains a FPGA that acts to buffer the pixel data, which is transferred into random access memory (RAM) storage for retrieval by a processor. Each image can be stored in RAM for processing as four-byte words. Various software routines, such as those provided with the Intel® Integrated Performance Primitives (IPP) software library, can be utilized to configure the processor with routines for image manipulation. Software can utilize memory mapping techniques, and call individual IPP routines to adjust pixel data to optimize the information content of each individual image. Each image captured by the CCD sensor 152 can be sequentially optimized and evaluated as they are acquired and buffered from the CCD sensor 152 to the processor. Images that do not provide sufficient detail can be discarded.

This optimization can be achieved by using the entire dynamic range of the CCD sensor 152 regardless of illumination conditions or camera settings. A histogram of an image (i.e., the number of pixels with captured intensities at each level of gray between black (0) and white (255)) can be adjusted or stretched over the available range to optimize the information over the dynamic range of the lens and sensor assembly. Images that are not severely under or over exposed provide the best data for edge detection analysis. In varying conditions, the exposure time, i.e., the length of time the CCD captures photons to create an image, must be adjusted to eliminate under exposure by increasing the exposure time, or to eliminate over exposure by decreasing the exposure time. For example, as a vehicle moves along a path the lighting conditions can rapidly change. Fast processing of images ensures that approximately eight to ten images are properly exposed and captured for analysis every second. In one embodiment thirty images (frames) are captured and evaluated to achieve approximately ten properly exposed images for edge detection analysis. Any images that are not properly exposed can be discarded after exposure analysis.

The overall camera architecture comprises an exemplary DCAM MCM Frame Capture module 126 and its internal data path that couples a 1394a electrical interface to a personal computer, and provides a digital signal processor (DSP) having DCAM software and a FPGA that can buffer the pixel data received from the SPTGM board 127 to provide commands to the SPTGM board 127.

A main circuit board 128 converts vehicle power, nominally twenty-eight volts, to regulated power required for thermoelectric coolers and the laser diode. It also hosts the control circuit for the laser diode 130 which provides for safe activation of the laser diode. The main circuit board 128 also includes a USB interface to couple system 100 to a commercial laptop computer that can include software to optimize images, extract important features from the images, collect wheel speed and steering angle of the vehicle from the vehicle's CAN bus (data bus), compare vehicle position and trajectory to the road ahead, predict vehicle path, and issue a warning signal if road departure is imminent.

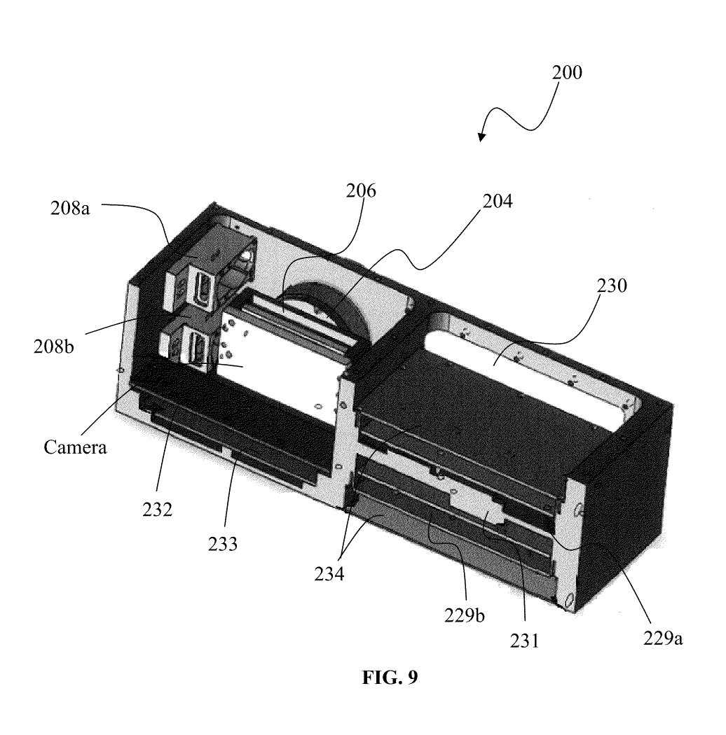

Referring to FIG. 9, one embodiment of a RDSS apparatus 200 does not require a separate laptop computer and instead includes a commercially available computer on a board, such as a computer on a module (e.g., COM-EXPRESS® as defined in PICMG® Specifications) having an Intel® Core 2 Duo SP9300 processor and a GS45 North Bridge (NB) interface.

FIG. 9 depicts a sectioned view through the RDSS apparatus 200 in a rectangular configuration. RDSS apparatus 200 includes optical assembly 204, CCD assembly 206, and two laser diode illuminator assemblies 208a and 208b, similar to the assembly 108 depicted in FIGS. 5-6. FIG. 9 also depicts the arrangement of two commercial processor boards 229a and 229b, the heat sink septum 231 which is an integral part of the housing 230. This view shows the signal board 232 and a power conditioning board 233. Two interface boards 234 for the commercial processor boards 229a and 229b are included to transfer data from the CCD assembly 206 to the processor boards (229a/b). The commercial processor boards 229a and 229b can provide more features than are required for basic NIRIS operation. Functions consistent with processing needs for the RDSS application can be achieved with a custom single or dual processor board that can be obtained at less cost than a commercially available board.

Housing 230, similar to the trapezoid configuration depicted in FIG. 3, can be fabricated from wrought aluminum alloy. The design for the housing 230 contains a septum 231 which contacts directly the microprocessors installed on boards 229a and 229b. Through this direct contact heat flows from the processors to the septum 231 and distributes heat away from the microprocessors into the housing 230, which cal allow the housing 230 to be sealed thereby preventing contamination or debris from the outside environment from entering housing 230.

In one embodiment, a computer processor board can be oriented such that the side with the heat generating processor chip set faces a center septum. The septum is an integral part of the housing and the primary thermal conduction path to remove heat. Zero degrees of rotation indicates the bottom board is flipped under the top board without rotation. Thermal analysis indicates that the 270-degree rotation is a preferred orientation to minimize hotspots and maximize thermal dispersion. This orientation permits a common interface PWB design to be used for both processors and eliminates interference of screws used in the interior of the processor boards. Thermal analysis of a prototype embodiment indicates that the temperature of the microprocessor in contact with a septum 231 at an ambient temperature of approximately 70° C. reaches a steady state temperature of approximately 89° C., which is generally within the operating temperature range of the microprocessor.

In one embodiment, a custom microprocessor board having one or more processors and integrated digital camera and human-machine interface connections can replace the microprocessor boards 229a/b. A custom board can be optimized to further manage and reduce the operating temperature of the apparatus 200.

Software embedded on the commercial computer board or a custom processor board can be used extensively to control the operation of the RDSS hardware. An important safety feature of RDSS is the control over the activation of the laser diode illumination. The processor(s) can be programmed to extract wheel-speed data from a vehicle's electronic systems and operate a laser diode illuminator only when the vehicle is in motion.

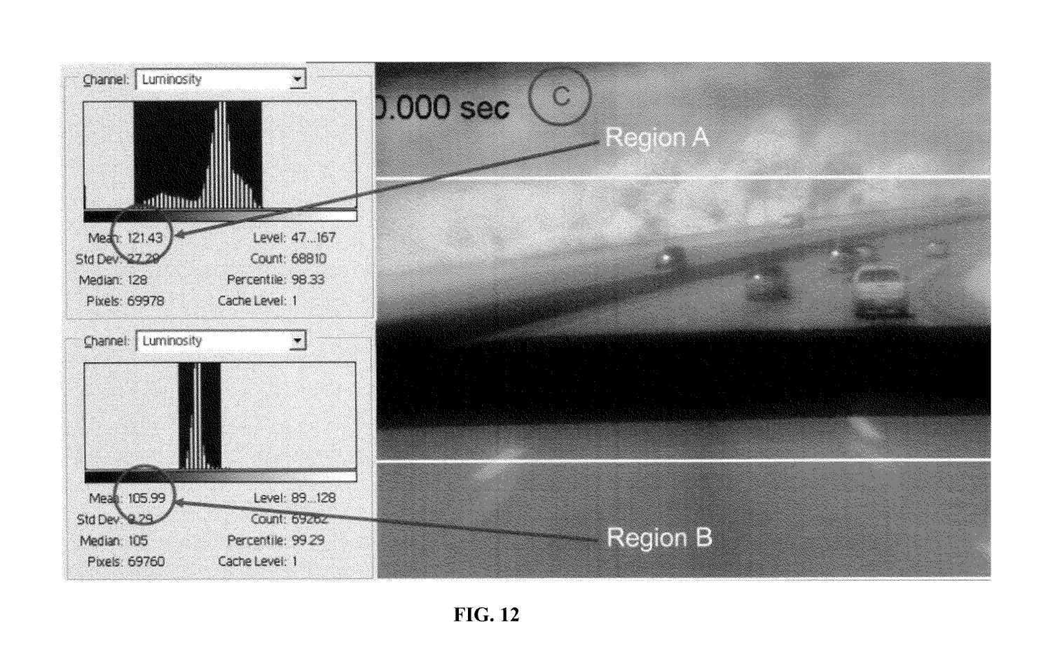

In order to prevent a moving vehicle from departing a surface, road or path, information from the entire field of view in front of the vehicle is not required. The drivable surface, road or highway, ahead of the vehicle is important. An important truism for a RDSS application is that the road edges tend to meet at a vanishing point beyond the horizon. The important region of the image is the portion that is immediately ahead of the vehicle to the horizon, as depicted in FIG. 10. This region, bounded by the road edges, is generally in the shape of a trapezoid. This trapezoid shape can be approximated by regions of interest (ROI) superimposed on a two-dimensional image, depicted in FIG. 11, that are labeled ROI C1, ROI C2, and ROI C3. Areas outside the depicted ROI can be ignored in order to reduce the processing demands, or only considered when evaluating the image as a whole for exposure evaluation to determine if an image is acceptable for further edge detection analysis.

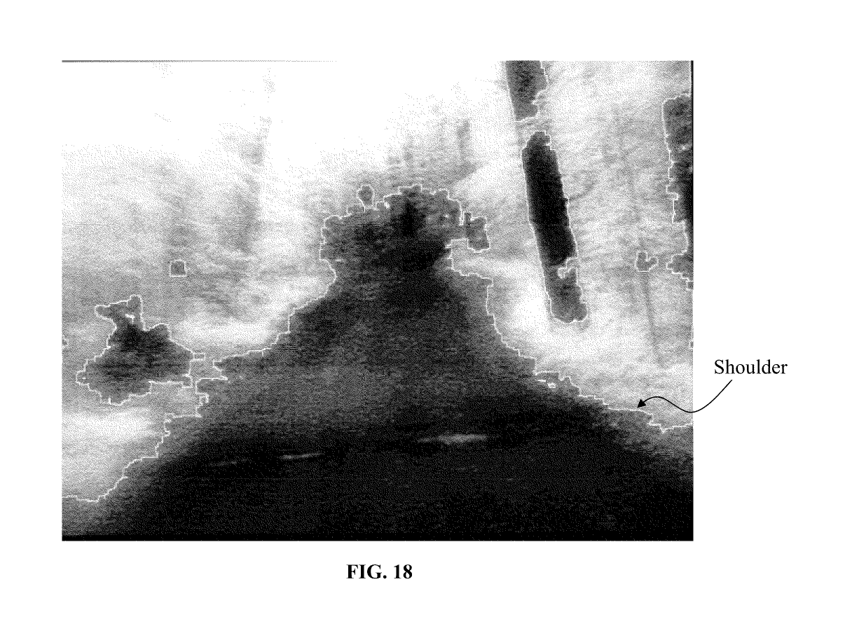

In the exemplary case of a CCD sensor with 480 vertical pixels, the top 96 rows of pixels can comprise a region farthest from the vehicle (and the NIRIS) labeled ROI A in FIG. 18, while the bottom 96 pixel rows comprise the region of the image closest to the vehicle are labeled ROI B. The processor can be configured conduct an evaluation of the average pixel intensity by calculating all pixels that comprise the image or an individual ROI. Depending on the speed of the vehicle priority can be given to an individual ROI. For example, at a high rate of speed (e.g., over sixty miles-per-hour), processing data from ROI B may be of little or no value as the vehicle will have entered the area depicted in ROI B before the vehicle operator could observe a RDSS warning and take action. In such a scenario priority can be given to processing ROI C1, C2 and C3 in order to provide timely warnings to the vehicle operator by effectively looking further ahead of the vehicle.

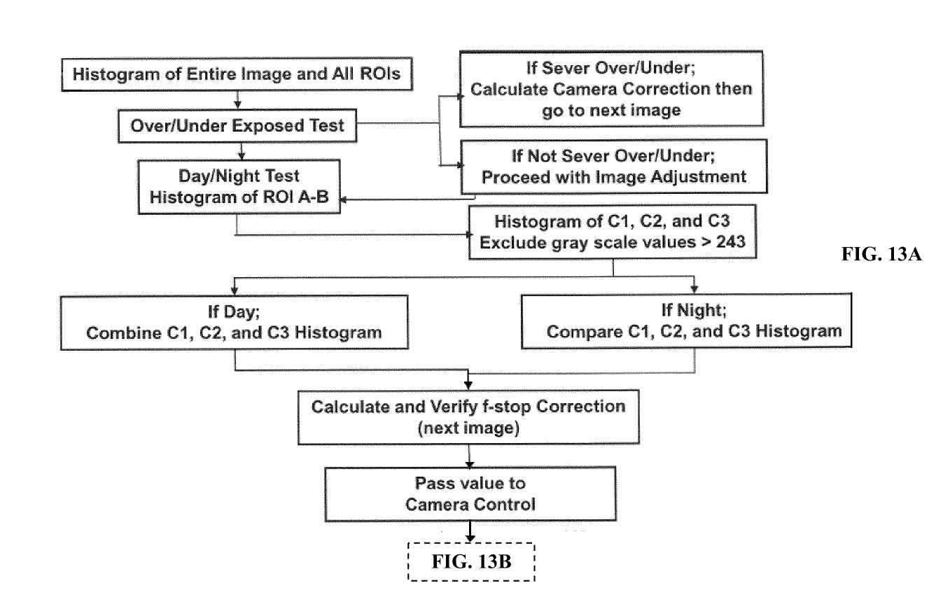

Referring to FIG. 12, an average histogram value for an image that can provide useful information should be approximately one-hundred-ten out of a possible range from zero to 255.A value less than seventy is typically under or over exposed which requires exposure-time adjustment of the image capturing hardware to produce a properly exposed image. FIG. 12 depicts an image where the average (mean) histogram value of approximately ninety-one with a range of 47-167. Region A of FIG. 18 has a mean histogram value of approximately one-hundred-twenty-one and Region B has a mean histogram value of approximately one-hundred-six. The black band above Region B in FIG. 18 was caused by a shadow from an overpass extending over the roadway. While the histogram for the entire image is approximately ninety, this area in ROI C1 is underexposed relative to the remainder of the image. Because the histogram of ROI C1 is under seventy, this individual ROI can be excluded from the edge detection analysis. Alternatively, if processing capacity is available, ROI C1 can be subdivided into two horizontal bands, the upper band comprising the underexposed black area and the lower band including the portion of ROI C1 that depicts the lane markings that can be analyzed.

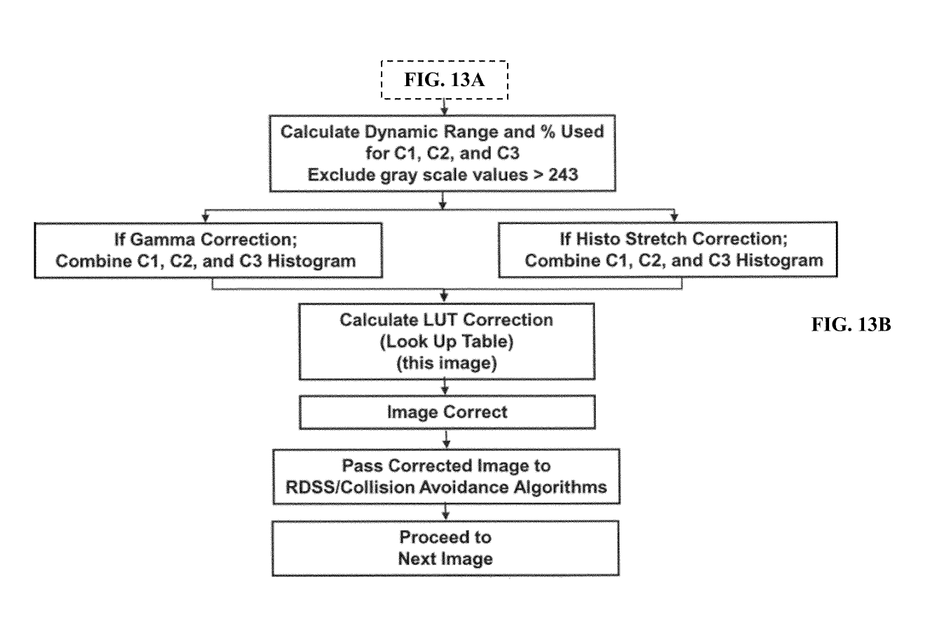

FIGS. 13A and 13B depict an exemplary decision scheme configured to operate with microprocessor boards 229a and 229b. This decision scheme can digitally adjust each image to utilize the full dynamic range of the camera and image sensor by stretching mildly under or over exposed images to the full dynamic range to enable useful information extraction.

Referring to FIG. 13A, the CCD sensor captures incoming photons through an optical assembly and a histogram is computed for the entire image and each ROI. Each photon produces one electron of charge which is stored in a pixel (an approximately 7×7 micrometer area). An exemplary CCD sensor can include an array of approximately 640 horizontal pixels and 480 vertical pixels. After a preset exposure time the CCD sensor sequentially releases the charge values stored in each pixel.

An initial test is performed to determine if the image was properly exposed. This test can include evaluating the entire image and discarding the image if the average histogram value for the image is less than seventy. If the image is under or over exposed appropriate correction is calculated, based on the average histogram value, and a subsequent image is acquired.

If the difference between the average pixel intensity of ROI A and ROI B is more than forty the image was acquired during night-time (darkened) conditions, typically with a longer exposure. A comparison of the histogram value for ROI C1, C2, and C3 can be conducted of images taken at night to account for the use of vehicle headlights, street lamps, or other lighting variations that may impact the exposure in each ROI. If the difference between the average pixel intensity of ROI A and ROI B is less than forty indicates that the image was acquired during daylight conditions, as depicted in FIG. 24. Under daylight conditions the C1, C2 and C3 ROI histogram values can be combined. The histogram data in both day and night conditions are then utilized to ensure that the proper exposure is obtained for the next image to be acquired. In this manner the exposure of the images can be refined and optimized to improve the quality of the subsequent edge-detection analysis. The operation of an RDSS in a brightly lit urban environment can impact the average pixel-intensity values and require minor adjustments to the exposure time.

A processor can change the exposure time between the collection of individual images by issuing a command to the CCD controller to change the exposure time of the CCD sensor. The next image collected will then have the new exposure time. Experimental results show that adjustments of information optimization take approximately 16 milliseconds using an INTEL® Core 2 Duo processor. At this rate of adjustments images can be acquired and evaluated for a first image before data for the next image arrives at the processor. This image pre-processing can ensure that an optimal image is captured in real time such that at least thirty frames per second (fps) are accurately acquired by the system.

Referring to FIG. 13B, the dynamic range of each ROI is calculated along with a calculation of the percentage of the available range that is utilized. Portions of the image that have a gray scale value over 243 can be excluded as these regions are effectively just white space. If the available range is not fully utilized, gamma correction or histogram stretching algorithms can be applied to the ROI to adjust the pixel values so that the entire tonal-range is being used. This is transformation can improve images that were captured in bad lightning conditions and can make the images sharper for further edge detection and highlight details that may be partially obscured by shadow. Once an image is optimized it can then be analyzed for edges and processing in combination with the vehicle trajectory by collision avoidance algorithms.

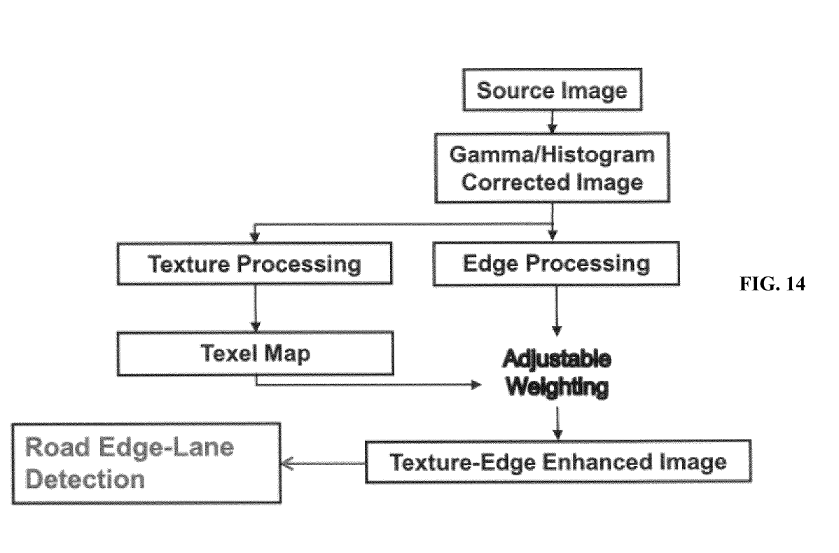

The algorithm depicted in FIG. 14, uses edge and texture changes in the region of interest (C1, C2, C3) to establish a road, and discern the drivable surface from an undesirable shoulder. By comparing the textures of the surfaces depicted in the ROI edges can be determined at the boundaries of the different textures. This process is performed on each properly exposed image. For example, tan colored dirt road may have the same color value as dry grasses at the side of the road but the two textures indicate the boundary between the drivable surface and a potentially soft shoulder.

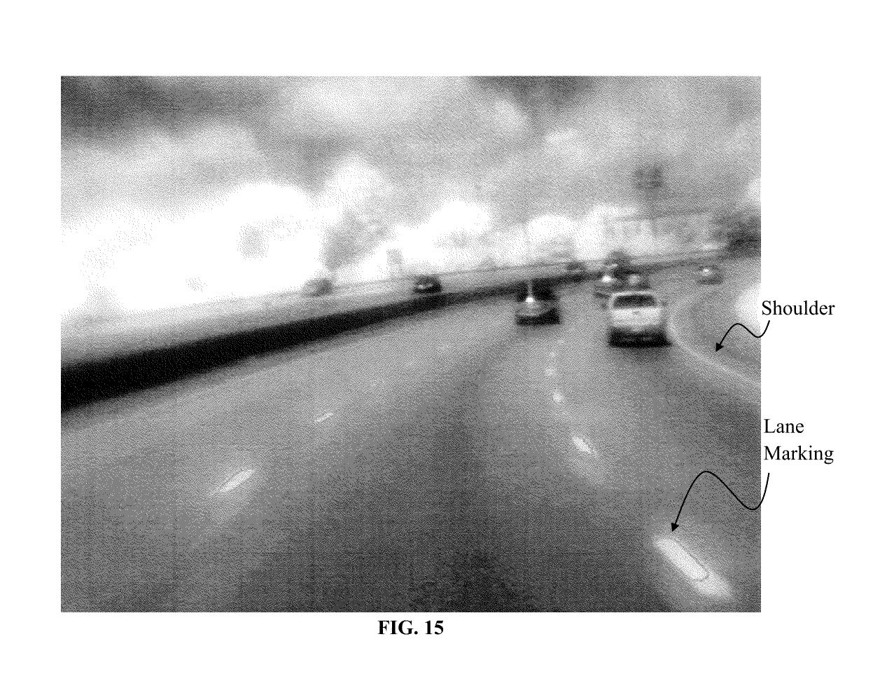

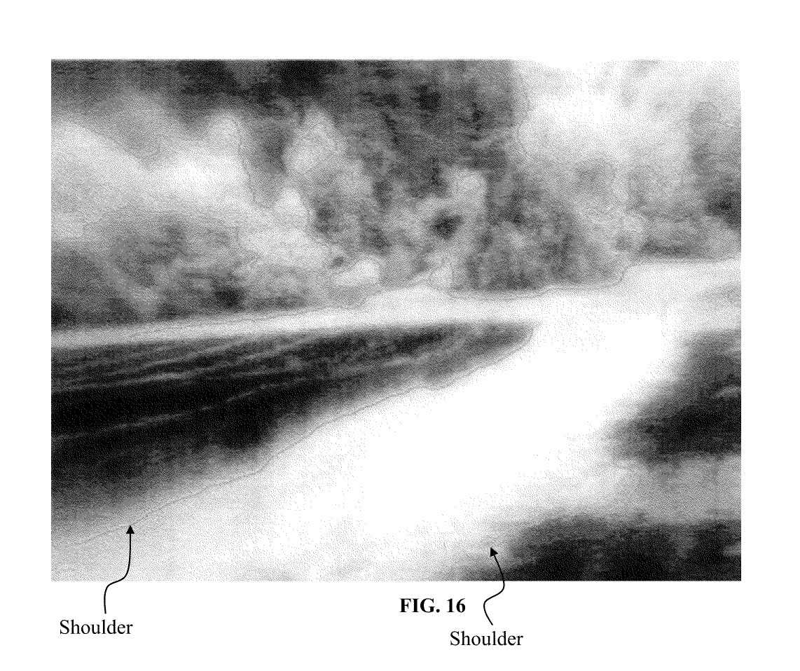

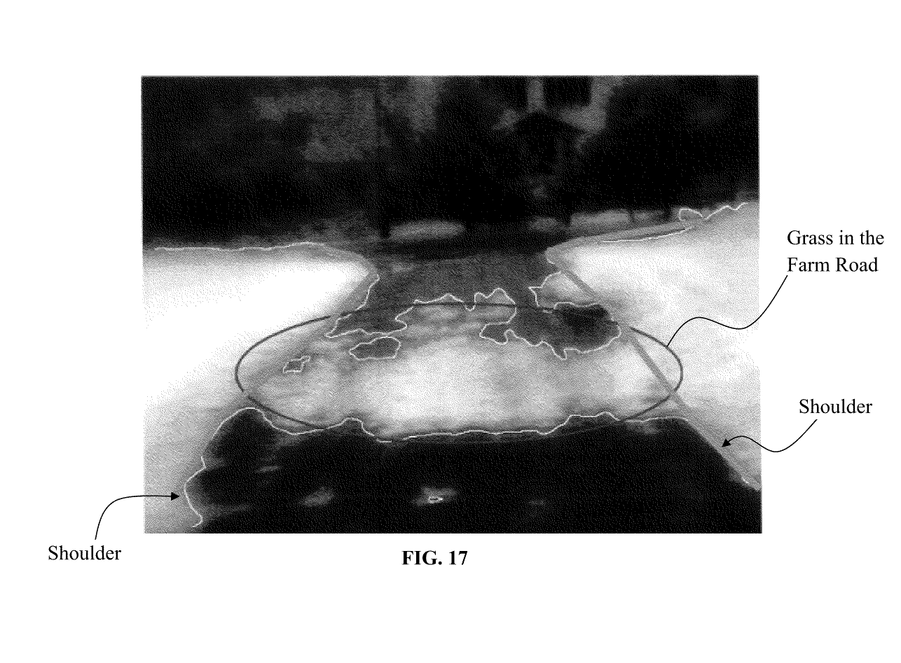

FIGS. 15 through 18 show examples of road scenes for which the algorithm of combined edge and texture detection finds the drivable road and establishes and segregates the non-drivable surface or road shoulder. The image analysis software extracts the road edge or lane markings from these images. As shown the highlighted edges of the road generally result in nearly linear paths that define the edges of the drivable surface. These edges are compared to the trajectory of the vehicle that is calculated based on the wheel speed and steering angle information of the vehicle. The wheels speed and steering angle information can be obtained from independent sensors nodes on the vehicle's CAN bus or other electronic monitoring system such as an integrated global positioning unit (GPS). The fixed position of a RDSS assembly on the vehicle provides fixed dimensions for the wheels of the vehicle relative to CCD sensor. This position information can be configured into the RDSS system at installation.

A captured RDSS image has a fixed horizontal and vertical field of view that can be calculated in degrees offset from the RDSS apparatus or the center of the vehicle. Plane geometry provides the wheel position relative to the road edge and trajectory information establishes an estimate for the future vehicle path based on the size and wheel base of the vehicle. If the vehicle and its speed indicate that the vehicle is more than three seconds from a road departure event then no warning is given. If a road departure event is calculated to be between two and three seconds from occurring a preliminary warning can be presented to the driver as a cautionary series of low beeps. If the RDSS calculates that there are less than two seconds until a road departure event the pitch and frequency of the preliminary warning beeps increases to alert the driver that immediate action is required to prevent the vehicle from departing the path of the road.

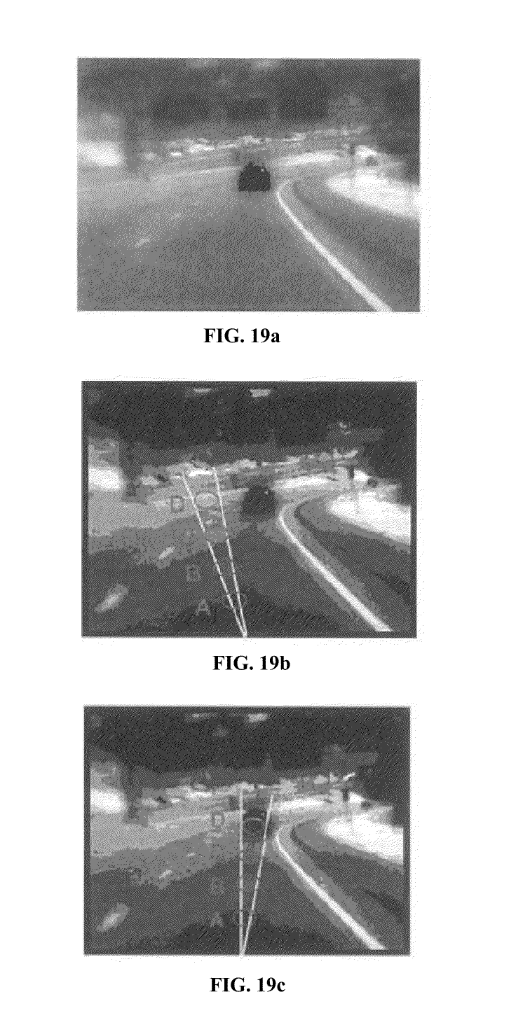

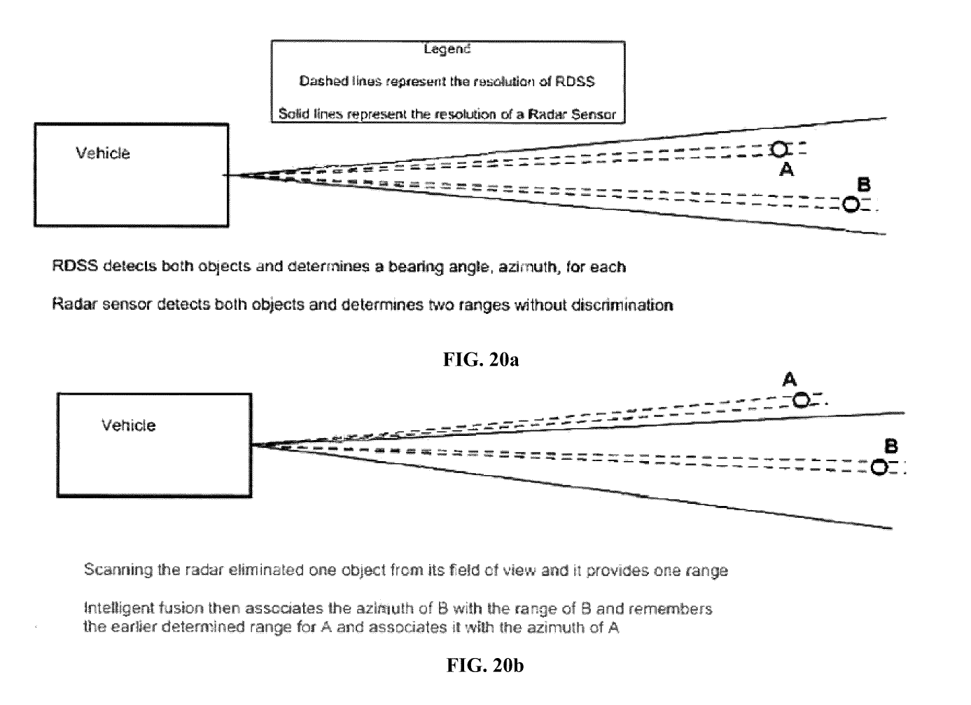

Referring to FIGS. 19a-19c and 20a and 20b, a RDSS system can be integrated with a radar sensor to increase the accuracy and obstacle avoidance capabilities of an autonomous vehicle. An IDSS includes of a Road Departure Sensing System (RDSS) that includes a near-infrared (IR) illuminated sensor and algorithms that provide an optimized image from the field of view ahead of a vehicle on which the RDSS is mounted. An illuminated sensor is preferred because a passive sensor will not discriminate between a compacted dirt road and a soft dirt shoulder; both materials have the same temperature and the same emissivity which a passive detector would represent as a uniform surface. The near IR Illuminated Sensor is able to discern uniquely the road edge for all types of roads in day or night conditions. The image provides a view of the drivable and non-drivable region and any objects in or near the path of the vehicle.

A range measuring device is also included with the sensor suite and can be used to detect objects, whether they are obstacles or obstructions, in the path of the vehicle and provides an instantaneous range from the vehicle to the object and bearing angle. As the range detector scans the area in front of the vehicle the RDSS can categorize objects at various distances and prioritize navigational warnings for those objects that are closest to the vehicle or most directly in the path ahead of the vehicle. Four different range categories A through D are depicted in FIGS. 19b and 19c. In FIG. 19b there are no objects located to the left of the vehicle's centerline within the range of the range finder. In FIG. 19c an object, a passenger car, is detected at category D ahead of the vehicle and along the forward path of the vehicle. A navigation algorithm fuses the range and bearing angle from the range measuring device with extent and bearing angle data from the RDSS images. This fusion results in designation of the object as an obstacle in terms of its extent, range, and bearing. Extent is the width of an object in the dimension parallel to the ground and perpendicular the path of the vehicle. Range is the distance from the vehicle to the object or the time until the vehicle reaches the object at the vehicle's current speed. Bearing is the angular direction of the object relative to the forward trajectory of the vehicle. This information is tracked and provided to a collision avoidance algorithm which in turn provides adjustment to the path of the vehicle to avoid collision with the object.

An object with finite extent is an obstacle, while one with infinite extent is an obstruction. The trajectory of the vehicle must be re-planned to avoid the obstruction while an object can be navigated around. The range measuring device may be an economical, addressable laser range finder or a commercial microwave (millimeter wavelength) radar device. Either of these components will provide the range and bearing information required with data from the IR image to navigate the vehicle to avoid an obstacle in its path or re-plan around an obstruction.

An Intelligent Driving Sensor Suite (IDSS) combining a RDSS and a Range Measuring Device (RMD), such as a laser range finder or a microwave radar sensor. The near-IR illuminated sensor is equipped with embedded computing capability and hosts algorithms for optimizing the information content of each image in the video stream in real time. The RDSS also hosts algorithms that determine frame-by-frame from the video stream using texture based techniques, the drivable surface ahead of the vehicle, the road boundary, e.g. FIG. 15, and any lane markings on structured roads. In addition, this system also finds objects on the drivable surface within the road boundary or lane markings The system hosts algorithms that can establish the extent of the object and its bearing angle with respect to the vehicle.

The RDSS then instructs the RMD to investigate the object at a specific bearing angle to the vehicle and report its range and bearing angle. The significance of the invention is the compensation the system, combined algorithm and hardware, makes for the relatively low resolution of the radar sensor, about three degrees, with the relatively high resolution afforded by the IR imaging sensor, about 0.04 degrees.

As shown in FIG. 20a, when the radar sensor detects (finds) two objects within its field of view (resolution is equal to the field of view for the radar sensor). The radar sensor returns two ranges to the algorithm. The algorithm instructs the radar to scan. The radar then provides one range return which the algorithm interprets as the range for Object B, FIG. 20b. The algorithm then assigns the other range return from FIG. 20a to Object A. The RDSS monitors and tracks each object encountered. The information about each object on the drivable surface is continuously transmitted to the computer hosting the collision avoidance software. This software uses the information to make corrections to the intended path of the vehicle to avoid obstacles and re-plan to maneuver around obstructions.

The design of IDSS includes shielding and a durable housing sufficient for extreme environmental requirements, such as use with military vehicles, and thereby is rugged and reliable in harsh environments.

The embodiments above are intended to be illustrative and not limiting. Additional embodiments are encompassed within the scope of the claims. Although the present invention has been described with reference to particular embodiments, those skilled in the art will recognize that changes may be made in form and detail without departing from the spirit and scope of the invention. For purposes of interpreting the claims for the present invention, it is expressly intended that the provisions of Section 112, sixth paragraph of 35 U.S.C. are not to be invoked unless the specific terms “means for” or “step for” are recited in a claim.

1. A method of avoiding and preventing road departure of a vehicle, the method comprising:
providing an infrared illumination source directed at a road ahead of the vehicle;
providing an infrared illumination detector configured to collect reflected infrared illumination reflected from the road ahead of the vehicle;
periodically collecting a set of data representing the reflected infrared illumination from the infrared illumination detector in a buffer;
retrieving the data from a buffer;
analyzing the data with a processor configured to detect the edges of a road depicted in the data; and
providing an alarm based on the analysis of the data by the processor if the vehicle is on a course that would cross the detected edges of the road.

2. The method of claim 1, further comprising:
coupling the processor to a vehicle wheel-angle detection device;
further configuring the processor to analyze a trajectory of the vehicle.

3. The method of claim 1, further comprising:
coupling the processor to a vehicle speed detection sensor;
further configuring the processor to periodically retrieve a speed of the vehicle from the vehicle speed detection sensor.

4. The method of claim 3, further comprising:
activating an infrared illumination source only when the speed of the vehicle exceeds a preset rate.

5. The method of claim 1, further comprising:
dividing the data from the buffer into a plurality of regions of interest.

6. The method of claim 5, further comprising:
calculating a mean luminosity for each of the plurality of the regions of interest.

7. The method of claim 1, further comprising:
calculating a mean luminosity for a plurality of images and discarding any one of the plurality of images that has a mean luminosity outside of a predefined range.

8. The method of claim 1, wherein the infrared illumination detector comprises a camera that includes a charge coupled device (CCD) and an exposure mechanism configured to control the amount of CCD exposure.

9. The method of claim 9, further comprising:
adjusting the exposure adjustment mechanism is adjusted in response to a calculation of a mean luminosity of the data received by the processor from the buffer.

10. The method of claim 9, further comprising:
providing a radar transceiver configured to collect reflected electronic signals reflected from an obstacle present in the road ahead of the vehicle; and
analyzing the reflected electronic signals with a processor configured to calculate the distance and bearing of the obstacle relative to the vehicle.

11. The method of claim 1, wherein the set of data representing the reflected infrared illumination from the infrared illumination detector is collected in the buffer at a rate of at least thirty data sets per second.

12. The method of claim 11, further comprising:
discarding a plurality of the collected data sets based on a calculated value indicated a quality of the exposure of a one of the collected data sets.

13. The method of claim 12, wherein the plurality of discarded data sets is approximately half of the collected data sets.

14. The method of claim 12, further comprising:
performing an edge detection analysis only on a plurality of the collected data sets that were not discarded.

15. The method of claim 14, further comprising:
comparing the edges of a road depicted in the data with a predicted trajectory of the vehicle.

16. A road departure prevention system comprising:
an infrared illumination source mounted on a vehicle;
an infrared illumination detector mounted on the vehicle;
a processor coupled to the infrared illumination detector, wherein the processor is configured to periodically retrieve a set of data from the infrared illumination detector; and
an alarm mechanism coupled to the processor;
wherein the processor is further configured to activate the alarm mechanism in response to at least two sets of data retrieved from the infrared illumination detector that indicates that the vehicle may encounter an edge of a path.

17. The road departure prevention system of claim 16, further comprising:
a vehicle speed detection device.

18. The road departure prevention system of claim 16, wherein the infrared illumination source includes a near infrared laser.

19. The road departure prevention system of claim 18, wherein the near infrared laser emits infrared electromagnetic radiation with a wavelength of approximately 808 nanometers.

20. The road departure prevention system of claim 16, wherein the infrared illumination detector comprises a camera that includes a charge coupled device (CCD).

21. The road departure prevention system of claim 20, wherein the camera further includes a narrow band filter.

22. The road departure prevention system of claim 20, wherein the camera further includes an optical collimator.

23. The road departure prevention system of claim 16, further comprising a radar transceiver mounted on the vehicle and coupled to the processor; wherein the processor is further configured to receive range and bearing angle for an obstacle in the path and provide an indication as to whether or not the vehicle will encounter the obstacle.

24. An autonomous vehicle comprising:
an infrared illumination source mounted on the vehicle;
an infrared illumination detector mounted on the vehicle;
a vehicle speed detection device;
a vehicle bearing sensor;
a processor coupled to the infrared illumination detector, wherein the processor is configured to periodically retrieve a set of data from the infrared illumination detector;
a radar transceiver mounted on the vehicle and coupled to the processor; and
an alarm mechanism coupled to the processor;
wherein the processor is further configured to activate the alarm mechanism in response to at least two sets of data retrieved from the infrared illumination detector that indicate that the vehicle may encounter an edge of a path;
wherein the processor is further configured to receive range and bearing angle for an obstacle in the path and provide an indication as to whether or not the vehicle will encounter the obstaclel.
